(19) United States
(12) Patent Application Publication
(10) Pub. No.: US 2026/0129304 A1
(43) Pub. Date: May 7, 2026

(54) IMAGING DEVICE AND CONTROL METHOD THEREOF

(71) Applicant: MEDIATEK INC., Hsinchu City (TW)

(72) Inventors: Chi-Cheng JU, Hsinchu City (TW); Yan-Shao LIU, Hsinchu City (TW); Yu-Chang HUANG, Hsinchu City (TW); Kai WEI, Hsinchu City (TW); Sheng-Jie LI, Hsinchu City (TW)

(21) Appl. No.: 19/375,833

(22) Filed: Oct. 31, 2025

Related U.S. Application Data
(60) Provisional application No. 63/716,276, filed on Nov. 5, 2024.

(51) Int. Cl. H04N 23/73; H04N 23/65; H04N 23/667

(52) U.S. Cl. CPC H04N 23/73; H04N 23/651; H04N 23/667

(57) ABSTRACT

An imaging device and a control method thereof are provided. The control method is configured to control a first-frame timing of a first imaging sensor. The method includes: obtaining an estimated value of an operation latency time, and obtaining a candidate target timing; determining, based on a current timing, the estimated value of the operation latency time, and the candidate target timing, an additional delay time; executing an additional delay operation with a duration equal to the additional delay time; and triggering a first-frame acquisition operation of the first imaging sensor. The operation latency time is a total duration from triggering the first-frame acquisition operation to the first imaging sensor starting an exposure phase. The additional delay time is configured to enable a timing of a preset synchronization event of a first frame of the first imaging sensor to synchronize with the candidate target timing.

### CROSS-REFERENCE TO RELATED APPLICATION

This application is a continuation application of U.S. Provisional Patent Application No. 63/716,276 filed on Nov. 5, 2024, which is incorporated herein by reference in its entirety.

### TECHNICAL FIELD

The present disclosure relates to the technical field of imaging technologies, in particularly relates to an imaging device and a control method thereof.

### BACKGROUND

After an imaging sensor is streamed on or switches its operation mode, it often needs to synchronize image frames with specific events, such as image frames from other imaging sensors, time windows of external events, etc. The first frame generated by the imaging sensor after streamed on or switching the operation mode is referred to as the “first frame”. However, before an imaging sensor starts readout of the exposure data, it must go through multiple stages including software configuration, hardware communication, internal sensor processing, and exposure. The involved software and hardware factors are complex, and there is a lack of a unified timing control mechanism. As a result, frame synchronization solutions may usually have to wait for several frames after the first frame to achieve the frame synchronization. Additionally, imaging sensors from different manufacturers or with different configurations may require separate development of timing synchronization programs, which further leads to issues such as poor versatility and high development costs of existing solutions.

### SUMMARY

According to a first aspect of the present disclosure, a method for controlling a first-frame timing of a first imaging sensor in an imaging device may be provided. The method may include: obtaining an estimated value of an operation latency time, and obtaining a candidate target timing; determining, based on a current timing, the estimated value of the operation latency time, and the candidate target timing, an additional delay time; executing an additional delay operation with a duration equal to the additional delay time; and triggering a first-frame acquisition operation of the first imaging sensor. The operation latency time may be a total duration from triggering the first-frame acquisition operation of the first imaging sensor to the first imaging sensor starting an exposure phase of the first-frame acquisition operation. The additional delay time may be configured to enable a timing of a preset synchronization event of a first frame of the first imaging sensor to synchronize with the candidate target timing.

According to a second aspect of the present disclosure, an imaging device may be provided. The imaging device may include a first imaging sensor and a processor that are electrically connected to each other. The processor may be configured to perform a first-frame timing control method for the first image sensor. The method may include: obtaining an estimated value of an operation latency time, and obtaining a candidate target timing; determining, based on a current timing, the estimated value of the operation latency time, and the candidate target timing, an additional delay time; executing an additional delay operation with a duration equal to the additional delay time; and triggering a first-frame acquisition operation of the first imaging sensor. The operation latency time may be a total duration from triggering the first-frame acquisition operation of the first imaging sensor to the first imaging sensor starting an exposure phase of the first-frame acquisition operation. The additional delay time may be configured to enable a timing of a preset synchronization event of a first frame of the first imaging sensor to synchronize with the candidate target timing.

### BRIEF DESCRIPTION OF THE DRAWINGS

In order to more clearly illustrate technical solutions in the present disclosure, the drawings required in the description of the embodiments will be briefly introduced below. Obviously, the drawings in the following description are only some embodiments of the present disclosure. For those of ordinary skills in the art, other drawings could be obtained based on these drawings without creative efforts and should fall within the scope of the present disclosure. Among the drawings:

FIG. 1 is a schematic structural view of an imaging device according to some embodiments of the present disclosure.

FIG. 2 is a schematic flowchart of an imaging sensor from power-on to stream on.

FIG. 3 is a timing diagram of an imaging sensor stream on according to the related art.

FIG. 4 is a schematic flowchart of a fast mode transition of an imaging sensor according to some embodiments of the present disclosure.

FIG. 5 is a schematic flowchart of a first-frame timing control method for a first imaging sensor of an imaging device according to some embodiments of the present disclosure.

FIG. 6 is a schematic flowchart of a first-frame timing control method for a first imaging sensor of an imaging device according to some other embodiments of the present disclosure.

FIG. 7 is a timing diagram of streaming on the first imaging sensor and achieving timing synchronization in the first frame of the first imaging sensor according to some embodiments of the present disclosure.

FIG. 8 is a timing diagram of streaming on the first imaging sensor and achieving frame synchronization with the second imaging sensor in the first frame of the first imaging sensor according to some embodiments of the present disclosure.

FIG. 9 is a timing diagram of achieving frame synchronization between the first imaging sensor and the second imaging sensor after streaming on the first imaging sensor according to the related art.

FIG. 10 is a timing diagram of streaming on the first imaging sensor and achieving frame synchronization with the second imaging sensor in the first frame of the first imaging sensor according to some embodiments of the present disclosure.

FIG. 11 is a timing diagram of achieving frame synchronization between the first imaging sensor and the second imaging sensor after streaming on the first imaging sensor according to the related art.

FIG. 12 is a timing diagram of streaming on the first imaging sensor and the second imaging sensor and allowing the first imaging sensor to achieve frame synchronization with the second imaging sensor in its first frame according to some embodiments of the present disclosure.

FIG. 13 is a timing diagram of streaming on the first imaging sensor and the second imaging sensor and achieving frame synchronization between the first imaging sensor and the second imaging sensor according to the related art.

FIG. 14 is a schematic flowchart of a first-frame timing control method for a first imaging sensor of an imaging device according to yet another embodiments of the present disclosure.

FIG. 15 is a timing diagram of streaming on the first imaging sensor according to the related art and some embodiments of the present disclosure respectively, when the second imaging sensor is streaming off.

FIG. 16 is a schematic flowchart of a first-frame timing control method for a first imaging sensor of an imaging device according to yet another embodiments of the present disclosure.

FIG. 17 is the timing of fast mode transition of the first imaging sensor according to the related art and some embodiments of the present disclosure when the second imaging sensor is in a streaming on state.

### DETAILED DESCRIPTION

Technical solutions in embodiments of the present disclosure will be described clearly and thoroughly in connection with accompanying drawings of the embodiments of the present disclosure in the following. It should be appreciated that, the specific embodiments described herein are for the purpose of explaining the present application only and but not for limiting it. It should also be noted that, for ease of description, the accompanying drawings show only part, but not all, of the structures relevant to the present disclosure. All other embodiments by a person of ordinary skills in the art based on embodiments of the present disclosure without creative efforts should all be within the protection scope of the present disclosure.

The terms “first” and “second” and the like in the present disclosure are used for distinguishing between different items and not for describing a particular sequence. In addition, the terms “include”, “comprise” and any variations thereof are intended to cover non-exclusive inclusion. For example, a process, a method, a system, a product, or a device that includes a series of operations or units is not limited to the listed operations or units, but optionally includes unlisted operations or units, or optionally also includes other operations or units inherent to these processes, methods, products or devices.

Reference to “embodiments” herein means that a specific feature, structure, or characteristic described in conjunction with the embodiments may be included in at least one embodiment of the present disclosure. The appearance of this phrase in various locations in the specification does not necessarily refer to the same embodiment, nor is it an independent or alternative embodiment mutually exclusive with other embodiments. Those skilled in the art may explicitly and implicitly understand that, the embodiments described herein may be combined with other embodiments.

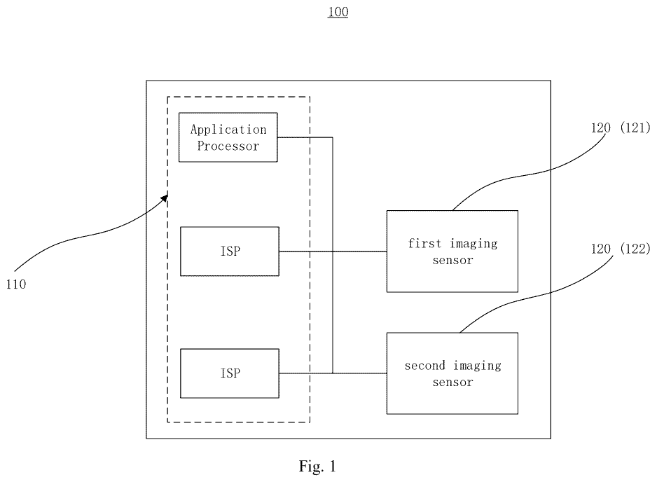

As illustrated in FIG. 1, FIG. 1 is a schematic structural view of an imaging device according to some embodiments of the present disclosure. The imaging device 100 may be, for example, a mobile phone, a smart phone, a tablet computer, a digital camera, or other such devices, which is not limited herein. An imaging sensor 120 may also be referred to as a camera sensor.

As illustrated in FIG. 1, the imaging device 100 may include a processor 110 and at least one imaging sensor 120. The processor 110 may be configured to be electrically connected to each of the at least one imaging sensor 120. The imaging sensor 120 may be, for example, a CMOS (complementary metal-oxide-semiconductor) sensor, a charge coupled device (CCD), or the like. For example, the at least one imaging sensor 120 may include a first imaging sensor 121 and a second imaging sensor 122. The first imaging sensor 121 and the second imaging sensor 122 may be each electrically connected to the processor 110. The number of the imaging sensors is not limited in the present disclosure. Different imaging sensors 120 may include, for example, different focal length ranges.

As illustrated in FIG. 1, the processor 100 may be, for example, an application processor (AP) or an image signal processor (ISP). The imaging device may be provided with at least one application processor. The imaging device may also, for example, be provided with one ISP for each imaging sensor. The ISP may be electrically connected to the matched imaging sensor. Each of a plurality of ISPs may be connected to the application processor.

In some embodiments, the processor may be configured to receive user hints (also referred to as user instructions) for imaging sensor stream on, imaging sensor stream off or imaging sensor mode transit, etc. For example, when the user commands to take a photo, adjust a focal length, or transit a shooting mode (such as a night scene mode, a portrait mode), the processor may receive the user hint, parses the user's requirements, determines to enable the data stream on of the imaging sensor, adjusts imaging parameters of the imaging sensor, or the like.

The imaging parameters of the imaging sensor may include, for example, a light sensitivity (ISO), an exposure time, a shooting mode, or the like, which is not limited herein.

The shooting mode may be, for example, a scene mode. The scene mode may include, for example, a sport mode, a portrait mode, a night scene mode, a landscape mode, a macro mode, a panorama mode, a high dynamic range (HDR) mode, a time-lapse photography mode, a slow-motion mode, a document scanning mode, or the like. A scene mode may correspond to a set of parameters. Different scene modes may include different parameter configurations. These parameters may include, for example, a shutter time, an aperture size, the ISO sensitivity, a white balance, an exposure compensation, a focusing method, a metering mode, an image sharpness, a color saturation, a noise reduction strength, a frame rate, or the like. By presetting scene modes that include different parameter configurations, an optimal imaging effect may be obtained by selecting a scene mode suitable for a specific scene.

The ISP may also be configured to process a raw data output from the imaging sensor. In some embodiments, the ISP may also be configured to instruct the imaging sensor to stream on, stream off, transit an operation mode, or the like, which is not limited herein.

The sensor and/or the ISP may communicate with the imaging sensor through specific communication protocols. Such communication protocols may include, for example, a mobile industry processor interface (MIPI) protocol, an inter-integrated circuit (I2C) protocol, or the like. For example, the processor may send configuration commands to the imaging sensor through the I2C protocol. The configuration commands may include configuration parameters of the imaging sensor, such as the exposure time, the gain, the white balance, or the like. The imaging sensor may for example communicate with the ISP through the MIPI protocol. For example, the exposure data (also referred to as the raw data) read out from the imaging sensor may be transmitted to the ISP through the MIPI protocol for further processing.

Before describing technical schemes of the present disclosure in detail, for convenience of understanding, the following several concepts may be briefed first.

### Standby Mode

In the standby mode, the imaging sensor may be in a low-power consumption, inactive state, but may still maintain basic power supply. During the standby mode, the imaging sensor does not perform exposure or data output, yet the imaging sensor may rapidly respond to a stream-on instruction to resume work.

Unlike a complete power-off state, the imaging sensor in the standby mode may retain part of its internal configuration information, which may reduce a time overhead required for re-power on and initialization.

In some embodiments, when the camera application of the imaging device runs in the background, the processor may place the image sensor in the standby mode, so as to reduce the power consumption. When the user activates the camera again, the image sensor can rapidly switch from the standby mode to the normal stream-on state or active mode, thereby shortening the resume time of the image sensor. The active mode of an imaging sensor may refer to an operational state where the imaging sensor is ready to perform core functions required for image capture and data output.

### Stream-On and Stream-Off

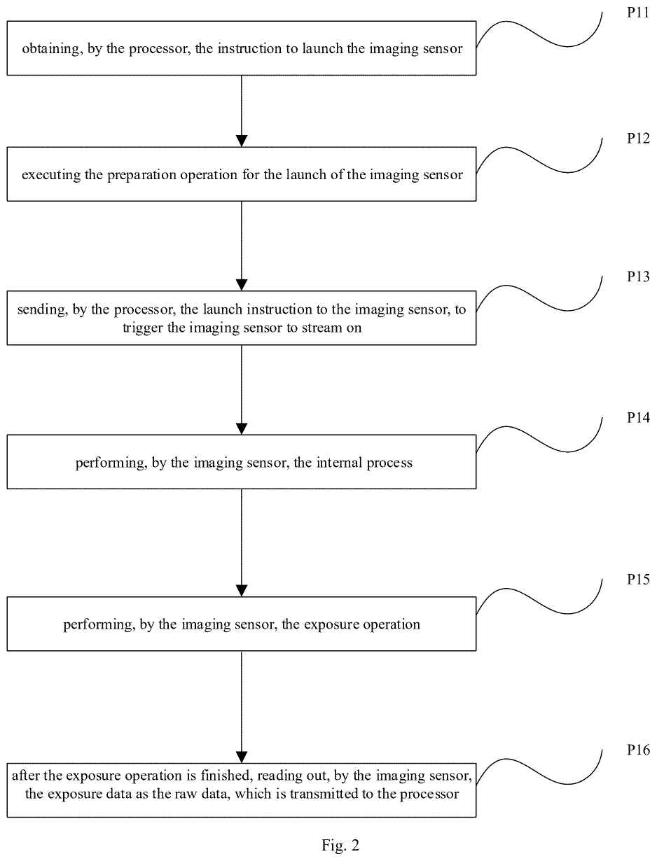

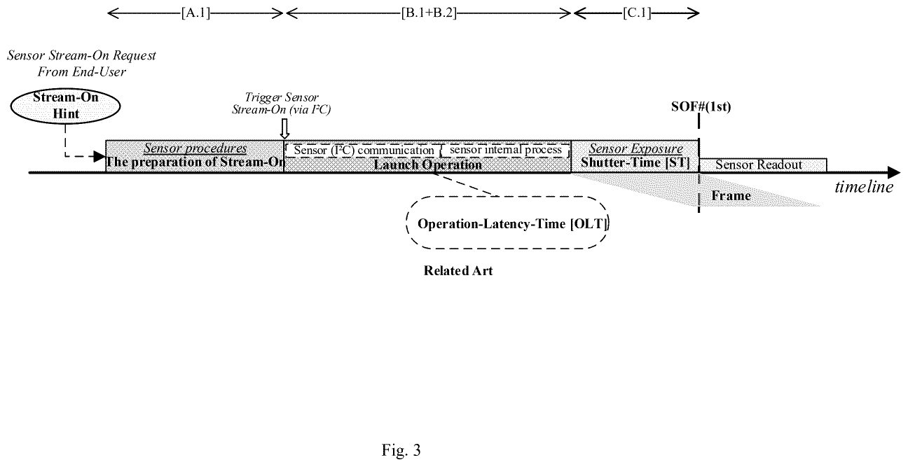

As illustrated in FIG. 2 and FIG. 3, FIG. 2 illustrates a flowchart of an imaging sensor from power-on to stream-on, FIG. 3 illustrates a timing diagram of an imaging sensor stream-on in the related art.

As illustrated in FIG. 2, in the related art, an imaging sensor may go through the following stages to achieve stream-on.

Stage P11: The processor obtains an instruction to launch the imaging sensor. In some embodiments, as illustrated in FIG. 3, the instruction may come from a user request. For example, the user may select a macro photography mode to instruct stream on of a corresponding macro imaging sensor, and the processor may then generate an instruction for launch the corresponding imaging sensor according to the instruction. In some embodiments, the processor may determine to launch a certain imaging sensor based on specific application scenarios, which is not limited herein.

In the present disclosure, launching the imaging sensor may generally refer to streaming on the imaging sensor. The launch instruction may also be referred to as a stream-on hint.

Stage P12: Perform a preparation operation for launching the imaging sensor.

This stage may correspond to the Stage A.1 of FIG. 3.

In some embodiments, the preparation operations may include at least one selected from the group consisting of: determining configuration parameters of the imaging sensor by the processor, performing a power-on procedure for the imaging sensor, mode configuration of the imaging sensor, initial setting of the imaging sensor, and/or switching the first imaging sensor from the standby mode to an active mode. These parameters may include, for example, shutter speed, aperture size, ISO sensitivity, white balance, exposure compensation, focusing method, metering mode, image sharpness, color saturation, noise reduction strength, frame rate, and the like. The mode configuration of the imaging sensor may be, for example, configuring the imaging sensor with the scene modes described above. The initial setting of the imaging sensor may include, for example, clock synchronization for the imaging sensors, initialization of a communication interface, configuration of the imaging sensor according to default parameters, or the like.

Stage P13: The processor sends a launch instruction to the imaging sensor, so as to trigger the imaging sensor to stream on.

This stage may correspond to Stage B.1 of FIG. 3.

In some embodiments, the processor may send the launch instruction to the imaging sensor through the communication protocol such as the I2C protocol. In other words, the processor may write the stream-on instruction to the imaging sensor. As illustrated in FIG. 3, this stage may be referred to as the sensor communication.

Stage P14: The imaging sensor performs a sensor internal process.

This stage may correspond to Stage B.2 of FIG. 3.

In the present disclosure, as described below, the Stages B.1 and B.2 may be collectively referred to as an Operation Latency Time (OLT). The operation latency time may vary with specific operation modes and hardware, and cannot be controlled easily, thereby affecting the first-frame timing sync of the imaging sensor.

In some embodiments, the imaging sensor may perform the parameter configuration and preparation work before the exposure phase according to the launch instruction from the processor. For example, the imaging sensor may set parameters such as resolution, gain, sensitivity, frame rate, and exposure duration according to the obtained configuration parameters, set an exposure counter, configure the control logic of the shutter, prepare a buffer, or the like.

Generally speaking, time consumption of this stage depends on the operation amount corresponding to the specific launch instruction and the hardware performance of the sensor itself, and duration of this stage may not be controlled by software.

Stage P15: The imaging sensor performs the exposure operation.

This stage may correspond to Stage C.1 in FIG. 3.

In some embodiments, the imaging sensor may perform the exposure operation based on a preset exposure time (also referred to as the shutter time). The imaging sensor may be in a single-exposure operation mode or a multiple-exposure operation mode, which will be explained in detail below.

Stage P16: After the exposure phase is completed, the imaging sensor may read out the exposure data and transmit the same to the processor as raw data.

This stage may be the sensor readout section in FIG. 3.

The imaging sensor may include a plurality of rows of pixels, a readout circuit, an interface circuit, or the like. The pixels may include photodiodes to convert received external light signals into electrons to form charge accumulation. The readout circuit may be configured to transfer the charge accumulation of the pixels to form electrical signals, and transmit the electrical signals to the processor as raw image data through the interface circuit. The operation of transferring the charge accumulation of the pixels by the readout circuit to form the electrical signals is the so-called exposure data readout. For example, the imaging sensor may transmit the raw image data to the ISP through the MIPI interface.

In some embodiments, the imaging sensor may be configured with a rolling shutter. The rolling shutter may read data from pixels row by row during the exposure process. For example, in the case where the imaging sensor is a CMOS image sensor, a row control circuit of the imaging sensor may sequentially trigger each row of pixels to perform exposure according to a fixed clock. After the exposure of each row of pixels is completed, the exposure data readout is performed immediately in row order.

In some embodiments, the imaging sensor may also be configured with a global shutter. In the case of a global shutter, all pixels of the imaging sensor may begin exposure at the same time and end exposure at the same time. After the exposure of the imaging sensor is completed, the readout circuit may read out the exposure data of all exposed pixels together.

The stream-on of the imaging sensor mentioned in the present disclosure may refer to enabling the imaging sensor to enter or resume a state of continuously exposing and outputting exposure data, which may also be referred to as a streaming-on state.

Correspondingly, stream-off of the imaging sensor may refer to enabling the imaging sensor to exit the streaming-on state. When streaming off the imaging sensor, the processor, including the AP or the ISP, may release at least some associated resources allocated to the imaging sensor. These associated resources may include resources related to maintaining the streaming-on state of the imaging sensor, including storage resources, memory and/or register resources, computing resources, communication bandwidth resources, or the like. After the imaging sensor is streamed off, the imaging sensor may enter a power-off state or a standby mode, and the present disclosure may not impose specific limitations herein.

### Single-Exposure Mode and Multiple-Exposure Mode

The single-exposure mode may refer to a mode where an imaging sensor performs only one complete exposure process when capturing one image frame. That is, each image frame corresponds to only one exposure process. The single-exposure mode is applicable to most common shooting scenarios.

The multiple-exposure mode may refer to a mode where an imaging sensor performs multiple independent exposure processes when capturing one image frame, and data from the multiple exposure processes may be combined into one single image frame. At least one configuration parameter among the multiple exposure processes, such as exposure duration, gain, ISO, white balance, etc., may be different. In the multiple-exposure mode, a single-frame image may contain information from multiple exposure processes, which may significantly increase the dynamic range or image quality of the image. The multiple-exposure mode may include a double-exposure mode or a mode with more exposure times.

Take an imaging sensor that is a stagger sensor and operates in the rolling exposure mode as an example. By way of example and not limitation, the odd-numbered rows of pixels of the stagger sensor may be configured for a first exposure process, with exposure performed sequentially starting from the first row of pixels; and, the even-numbered rows of pixels may be configured for a second exposure process, with exposure performed sequentially starting from the second row of pixels. After the exposure of each row of pixels is completed, the corresponding exposure data readout may be performed. In the present disclosure, among the multiple exposure processes of the first frame, the exposure process where the exposure data readout starts last may be referred to as the last exposure process.

### Start of Frame (SOF)

The following description takes an imaging sensor configured with the rolling shutter as an example. The imaging sensor may start an exposure process from the first row of a frame (also referred to as an image frame), and the exposure duration is the shutter time configured as described above. When the exposure of the first row of pixels of the imaging sensor ends, the imaging sensor outputs the exposure data of the first row of pixels to a receiving end (e.g., a processor, usually an ISP). The receiving end may start to acquire data of the first row of the image frame, and this very starting moment is referred to as the Start of Frame (SOF). When the exposure of the last row of pixels of the imaging sensor ends, the entire exposure phase of the image frame of the imaging sensor ends.

In the multiple-exposure mode, SOF usually may refer to the moment when the exposure data of an image frame of the imaging sensor starts to be output. At this time, SOF generally also refers to the moment when the exposure data readout of the first row of pixels of the imaging sensor starts.

In some embodiments, the imaging sensor may be configured with a global shutter as described above. In this case, when the exposure of all working pixels of the imaging sensor ends, the imaging sensor outputs the exposure data of these pixels to the receiving end (e.g., the processor, usually the ISP). The receiving end starts to acquire data of the image frame, and this starting moment is referred to as the Start of Frame (SOF).

### Fast Mode Transit

The Fast Mode Transit may refer to fast transit of an imaging sensor from one imaging mode to another. Compared with general mode transit, in the Fast Mode Transit, the imaging sensor does not need to stream off. Therefore, the imaging sensor does not need to go through a standby mode, but may complete mode switching during a continuous frame output process, thereby accelerating the switching speed. The Fast Mode Transit may be applied to scenarios that require real-time response, such as adjusting the scene mode in real time during shooting or recording, and quickly switching from one scene mode to another.

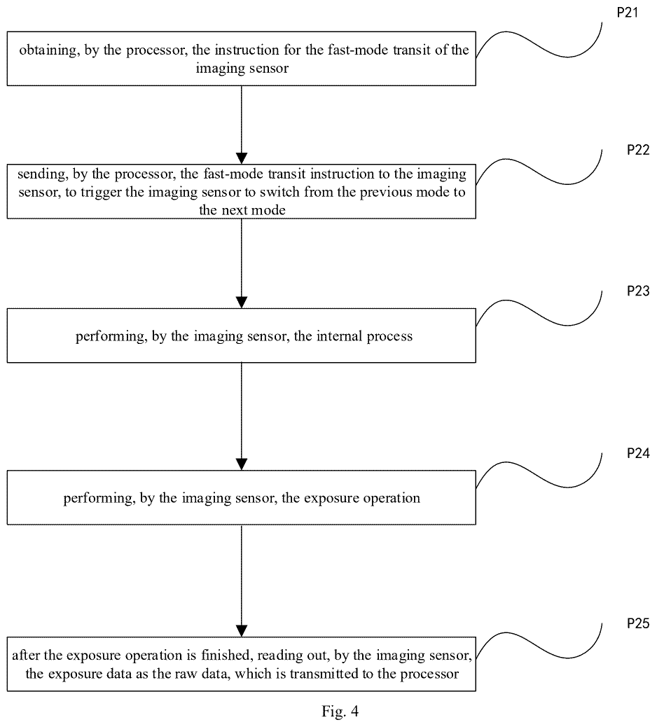

Referring to FIG. 4, FIG. 4 illustrates a schematic flowchart of Fast Mode Transit of an imaging sensor according to some embodiments of the present disclosure.

As illustrated in FIG. 4, in the related art, the imaging sensor may go through the following stages to achieve the Fast Mode Transit.

Stage P21: The processor obtains an instruction indicating the imaging sensor to perform Fast Mode Transit. In some embodiments, the instruction may come from the user hint. For example, the user may adjust the shooting mode, so as to instruct the imaging sensor to perform Fast Mode Transit. In some embodiments, the processor may also determine that the imaging sensor performs Fast Mode Transit according to changes in specific application scenarios, which is not limited herein.

Stage P22: The processor sends a Fast Mode Transit instruction to the imaging sensor, to trigger the imaging sensor to perform Fast Mode Transit.

In some embodiments, the processor may send the Fast Mode Transit instruction to the imaging sensor through a communication protocol such as the I2C protocol. In other words, the processor may write the Fast Mode Transit instruction to the imaging sensor.

Stage P23: The imaging sensor performs the internal processing.

In some embodiments, the imaging sensor may perform mode switching and preparation operation before the exposure phase in the new mode according to the Fast Mode Transit instruction from the processor. For example, the imaging sensor may set parameters such as resolution, gain, sensitivity, frame rate, and exposure duration according to the obtained configuration parameters, set an exposure counter, configure the control logic of the shutter, prepare a buffer, or the like.

Generally speaking, a time consumption of this stage may depend on the operation amount corresponding to the specific Fast Mode Transit and the hardware of the imaging sensor itself. The duration of this stage cannot be controlled by software.

Stage P24: The imaging sensor performs the exposure operation.

This stage is similar to Stage P15 described above, and would not be repeated here.

Stage P25: After the exposure is completed, the imaging sensor may read out the exposure data and transmits the exposure data to the processor as raw data.

This stage is similar to Stage P16 described above, and would not be repeated here.

### First-Frame Timing Control

In the present disclosure, the term “first frame” or “1st frame” may include: the first frame of the imaging sensor after it enters the streaming-on state from a power-off state or a standby mode; and/or, the first frame of the imaging sensor in the switched imaging mode after the imaging sensor performs Fast Mode Transit. Since the working state of the imaging sensor may change significantly in the above two cases, it is necessary to re-perform timing control to achieve timing alignment with other imaging sensors or external objects, especially frame alignment (or frame sync).

In the present disclosure, the operation of the imaging sensor to acquire the first frame may be referred to as a first-frame acquisition operation. Generally, the first-frame acquisition operation may include the exposure phase and the exposure data readout phase. In some embodiments, it may also be considered that, the first-frame acquisition operation may further include an internal processing phase before the exposure phase, i.e., the Stage P14 described above with reference to FIG. 2.

In the present disclosure, the goal of the first-frame timing control may be to ensure that the timing of a preset synchronization event of the first frame of the imaging sensor is synchronized with a candidate target timing.

In some embodiments, when the imaging sensor operates in the single-exposure mode, the preset synchronization event may refer to the start of the first frame (SOF).

For example, the imaging sensor may include a first imaging sensor and a second imaging sensor, each electrically connected to the processor. Both the first imaging sensor and the second imaging sensor operate in the single-exposure mode. The goal of the first-frame timing control for the first imaging sensor may be to control the start time of the first frame of the first imaging sensor to be aligned with the start time of a certain frame of the second imaging sensor. Here, the candidate target timing may refer to the start time of a certain frame of the second imaging sensor. The certain frame of the second imaging sensor here specifically refers to a frame after the launch instruction or fast switching instruction of the first imaging sensor is obtained, which may also be referred to as a future frame in the present disclosure.

In some embodiments, when the imaging sensor operates in the multiple-exposure mode, the preset synchronization event may also refer to the start time of the exposure data readout of the last exposure process of the first frame. As described above, for a frame in the multiple-exposure mode, the exposure process whose exposure data readout starts last may be referred to as the last exposure process.

For example, the imaging sensor may include the first imaging sensor and the second imaging sensor, each may be electrically connected to the processor. Both the first imaging sensor and the second imaging sensor may operate in the multiple-exposure mode. The goal of the first-frame timing control for the first imaging sensor may be to control the start time of the exposure data readout of the last exposure process of the first frame of the first imaging sensor to be aligned with the start time of the exposure data readout of the last exposure process of a future frame of the second imaging sensor. Here, the candidate target timing may refer to the start time of the exposure data readout of the last exposure process of the second imaging sensor.

In some embodiments, the candidate target timing may also refer to a time after another imaging sensor has been streamed off. For example, the imaging sensor may include the first imaging sensor and the second imaging sensor, each electrically connected to the processor. It is intended to stream on the first imaging sensor and stream off the second imaging sensor. In this case, if the hardware resources of the processor (e.g., ISP) are limited, the exposure data of the first frame or other frames of the first imaging sensor may not be successfully read out by the processor, if the data stream of the second imaging sensor is not completely streamed off and the processor does not completely release associated resources allocated for the stream-on operation of the second imaging sensor. That is, the data of the first frame or other frames of the first imaging sensor may be lost. For this reason, the candidate target timing may be set to the timing when the processor successfully releases, after the second imaging sensor is streamed off, the associated resources allocated for the stream-on operation of the second imaging sensor.

In some embodiments, the candidate target timing may also refer to the timing of another external events. For example, in a scenario where an imaging device is used to capture an object, to capture a specific event, the candidate target timing may be a precise moment of a predetermined action associated with the object. For example, on an automated production line, when a robot completes grabbing a part and placing the same at a detection position, the candidate target timing may be set to the moment of the “placement completion” signal sent by the robot control system, the moment when the robotic arm reaches a preset coordinate position, or the moment when a production line sensor (such as a photoelectric switch, a pressure sensor) detects that the part is in place. In this way, it may be ensured that, imaging is performed for a period of time after the part reaches the optimal detection position, thereby significantly improving the accuracy and efficiency of machine vision detection.

### Operation-Latency-Time (OLT)

In the present disclosure, the Operation-Latency-Time (OLT) may refer to a total duration from triggering the first-frame acquisition operation of an imaging sensor to the imaging sensor starting the exposure phase of the first-frame acquisition operation.

In some embodiments, when the first-frame acquisition operation is the stream-on of the imaging sensor, the Operation-Latency-Time may refer to the total duration from the processor sending a stream-on instruction to the imaging sensor to the imaging sensor starting the exposure phase of the first frame. This total duration may correspond to the total duration of Stages P13 and P14 described above with reference to FIG. 2, and may also be referred to as a launch latency.

The launch latency may vary with the operation mode of the first frame and hardware. In the present disclosure, the estimated value of the launch latency may be obtained through a first type of integrator. The integrator may be configured to collect actual values of the Operation-Latency-Time of a plurality of first frames of the imaging sensor, and perform statistical processing on these actual values to generate the estimated value. The integrator may perform the estimation based only on the latest N actual values, and abnormal historical actual data shall be excluded during the estimation. N is an integer greater than 1.

Each integrator may correspond to only one operation mode of one imaging sensor. The operation mode may refer to the configuration mode of the imaging sensor, which may include resolution, cropping position, frame rate, data transmission rate, or the like.

In some embodiments, the integrator may be implemented as a circuit in the imaging sensor, a software application, or the like, which is not limited herein.

As illustrated in Table 1, Table 1 illustrates an example of the first type of integrator according to some embodiments of the present disclosure. The first type of integrator may also be referred to as a launch-OLT integrator.

TABLE 1

| sensor on | configuration | |
|---|---|---|
| the device | of the device | Launch-OLT integrator serial NO. |
| Sensor A | Mode (1) | Launch-OLT Integrator [1] |
| Sensor A | Mode (2) | Launch-OLT Integrator [2] |
| Sensor A | Mode (3) | Launch-OLT Integrator [3] |
| Sensor B | Mode (1) | Launch-OLT Integrator [4] |
| Sensor B | Mode (2) | Launch-OLT Integrator [5] |
| Sensor C | Mode (1) | Launch-OLT Integrator [6] |

As illustrated in Table 1, the imaging sensors may include three imaging sensors, namely Sensor A, Sensor B, and Sensor C. These sensors may include different operation modes. For example, Sensor A may correspond to three operation modes: Mode (1), Mode (2), and Mode (3). Sensor B may correspond to two operation modes: Mode (1) and Mode (2). Sensor C may correspond to one operation mode: Mode (1). In the present disclosure, one launch-OLT integrator may be assigned to each operation mode of each sensor. The integrator may collect the launch time taken by the corresponding imaging sensor to enter the stream-on state of the corresponding mode. Specifically, the processor may record the timestamp TS_{on-begin} of sending the stream-on instruction to the imaging sensor and the time TS_{SOF} of the first-frame SOF (Start-Of-Frame). Then, the calculation formula for the launch OLT duration in this case is OLT=TS_{SOF}−TS_{on-begin}−Tₛₕᵤₜₜₑᵣ. Tₛₕᵤₜₜₑᵣ is the exposure duration of the first frame. The integrator may record specific OLT data, and perform statistical analysis on the data to provide an estimated value of OLT. The statistical analysis may include, for example, eliminating abnormal OLT values, calculating the average value of historical OLT data, etc., which is not limited herein.

In some embodiments, in a case where the first-frame acquisition operation is the fast mode transit of the imaging sensor, the operation latency time may refer to the total duration from the processor sending the stream-on instruction to the imaging sensor to the imaging sensor starting the exposure phase in the new operation mode. This total duration corresponds to the total duration of Stages P22 and P23 described above with reference to FIG. 3, and may also be referred to as a transit latency. The transit latency may vary with the switching of different operation modes, switching directions, and hardware. In the present disclosure, the estimated value of the transit latency may be obtained through a second type of integrator. The second type of integrator may be configured to, when the additional delay operation is performed, collect the actual values of the operation latency time for the imaging sensor to switch from the current mode to the target mode. The second type of integrator is also configured to perform statistical processing on the collected actual values to generate the estimated value. Each integrator may correspond to only one operation mode switching scenario of the first imaging sensor. The operation mode refers to the configuration mode of the imaging sensor, which may include resolution, cropping position, frame rate, data transmission rate, or the like.

The integrator may perform the estimation based only on the latest N actual values, and abnormal historical actual data shall be excluded during the estimation. N may be an integer greater than 1.

In some embodiments, the integrator may be implemented as a circuit in the imaging sensor, a software application, or the like, which is not limited herein.

As illustrated in Table 2, Table 2 illustrates an example of the second type of integrator according to some embodiments of the present disclosure. The second type of integrator may also be referred to as a transit-OLT integrator.

TABLE 2

| | | |
|---|---|---|
| | | Switch OLT- |
| Sensors on | Scenario(s) of this Sensor | Integrator |

| the device | Previous mode | Next mode | serial No. |
|---|---|---|---|
| Sensor-A | Mode(1) | Mode(2) | Switch-OLT- |
| | | | Integrator[1] |
| Sensor-A | Mode(1) | Mode(3) | Switch-OLT- |
| | | | Integrator[2] |
| Sensor-A | Mode(2) | Mode(1) | Switch-OLT- |
| | | | Integrator[3] |
| Sensor-A | Mode(2) | Mode(3) | Switch-OLT- |
| | | | Integrator[4] |
| Sensor-A | Mode(3) | Mode(1) | Switch-OLT- |
| | | | Integrator[5] |
| Sensor-A | Mode(3) | Mode(2) | Switch-OLT- |
| | | | Integrator[6] |
| Sensor-B | Mode(1) | Mode(2) | Switch-OLT- |
| | | | Integrator[7] |
| Sensor-B | Mode(2) | Mode(1) | Switch-OLT- |
| | | | Integrator[8] |
| Sensor-C | Mode(1) | Mode(2) | Switch-OLT- |
| | | | Integrator[9] |

As illustrated in the Table 2, the imaging sensors may include three imaging sensors, namely Sensor A, Sensor B, and Sensor C. These sensors may include different operation modes. The imaging sensor may switch from a previous mode (i.e., the current mode) to a subsequent mode (i.e., the target mode). In the present disclosure, the switch-OLT integrator may be assigned to each switching scenario of each sensor. It should be noted that, the switching scenario from the first mode to the second mode is different from the switching scenario from the second mode to the first mode, and different integrators shall be assigned accordingly.

The integrator may collect a transit time taken by the corresponding imaging sensor to switch from the current mode to the target mode. Specifically, the processor may record the timestamp TS_{switch-begin} of sending the mode-switching instruction to the imaging sensor and the time TS_{SOF} of the first-frame SOF (Start-Of-Frame). Then, the calculation formula for the transit OLT duration in this case is OLT=TS_{SOF}−TS_{switch-begin}−Tₛₕᵤₜₜₑᵣ. Among them, Tₛₕᵤₜₜₑᵣ may be the exposure duration of the first frame after switching. The integrator may record specific OLT data and perform statistical analysis on the data to provide an estimated value of OLT. The statistical analysis may include, for example, eliminating abnormal OLT values, calculating the average value of historical OLT data, etc., which is not limited herein.

In the present disclosure, the integrators, whether the launch-OLT integrators or the switch-OLT integrators, may be configured with initial OLT values calibrated or provided by the manufacturer of the imaging device, or may be configured with default values provided based on experience, or the like. During the subsequent operation of the imaging device, these initial OLT values or default values may be continuously optimized based on subsequent actual measurement values and statistical analysis results.

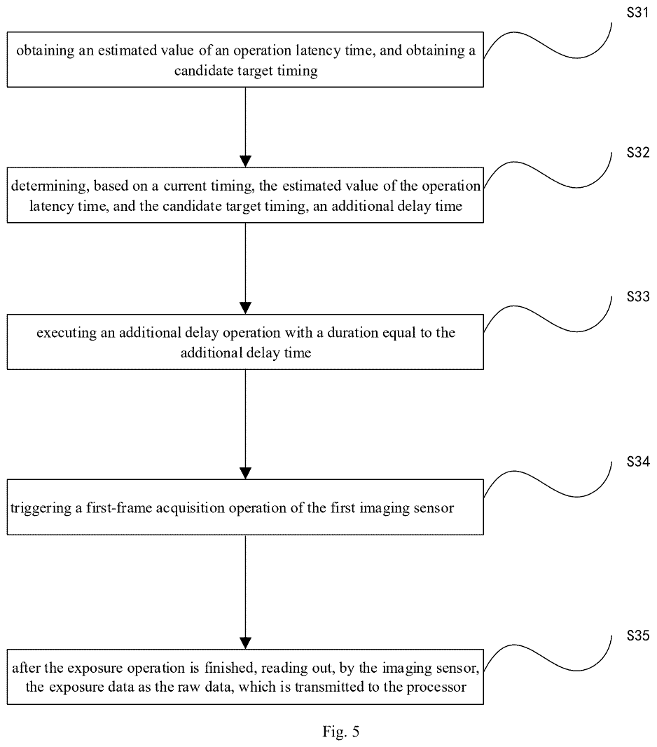

As illustrated in FIG. 5, FIG. 5 is a schematic flowchart of a first-frame timing control method for a first imaging sensor of an imaging device according to some embodiments of the present disclosure. The method may include the following operations as illustrated at blocks of FIG. 5.

The operation at block S31: Obtaining an estimated value of the operation latency time, and obtaining a candidate target timing.

As described above, the operation latency time may refer to a total duration from triggering the first-frame acquisition operation of the first imaging sensor to the first imaging sensor starting the exposure phase of the first-frame acquisition operation.

In some embodiments, the candidate target timing may be, for example, a series of candidate timestamps TS_{target}[n], where n is a positive integer, such as {n=1, 2, 3, 4 . . . }. That is, the timestamps are a series of candidate timestamps. In some embodiments, the candidate target timing may also be a specific time point, which is not limited herein.

The operation at block S32: Determining an additional delay time (ADT) based on a current timing, the estimated value of the operation latency time, and the candidate target timing.

Specifically, the additional delay time may be configured to enable the timing of the preset synchronization event of the first frame of the first imaging sensor to be synchronized with the candidate target timing.

In some embodiments, the additional delay time (Added Delay Time, ADT) is calculated by subtracting the sum of the current timing, the estimated value of the operation latency time, and the first time interval of the first imaging sensor from the candidate target timing. That is, ADT=

$$T {S}_{target} [ n ] - T {S}_{n o w} - {OLT}_{estimated} - T {D}_{first} \qquad ( 1 )$$

Wherein, TS_{now} is the current timing or current timestamp, which may generally refer to a timing before the processor starts the ADT operation. OLT_{estimated} is the estimated value of the operation latency time, which may be obtained from the integrator described above, for example. TD_{first} is the first time interval.

In the process of calculating ADT according to the Formula (1), the calculation may start from a case of n=1. If the calculated ADT result is a value greater than or equal to 0, the calculation is stopped, and the current ADT result is used for subsequent operations. On the contrary, if the calculated ADT result is a negative number, it indicates that the first-frame sync cannot be achieved at the current candidate timestamp TS_{target}[n]; increasing or incrementing n by 1, and the calculation of the corresponding ADT is continued until the calculated ADT is greater than or equal to 0.

Specifically, the first time interval is the duration from the start of the exposure phase to the preset synchronization event in the first frame of the first imaging sensor. For example, when the first imaging sensor is in the single-exposure mode, the preset synchronization event may be the SOF of the first frame of the first imaging sensor. When the first imaging sensor is in the multiple-exposure mode, the preset synchronization event may be the start of the exposure data readout of the last exposure process of the first frame of the first imaging sensor.

The operation at block S33: Executing an additional delay operation with a duration equal to the additional delay time.

In some embodiments, during the additional delay operation, the processor does not send any operation instructions to the first imaging sensor, and the first imaging sensor does not perform any operations accordingly.

The operation at block S34: Triggering the first-frame acquisition operation of the first imaging sensor.

In the technical scheme of the present disclosure, by determining the additional delay time and executing, before triggering the first-frame acquisition operation of the first imaging sensor, the additional delay operation with a duration equal to the additional delay time, it may be ensured that the timing of the preset synchronization event of the first frame of the first imaging sensor is synchronized with the candidate target timing. Through the technical scheme of the present disclosure, the first imaging sensor may achieve the desired alignment at the first frame, thereby avoiding problems such as picture freezes, data loss, missed shooting opportunities, or synchronization delays caused by first-frame timing deviations in the related art. Moreover, the technical scheme of the present disclosure does not rely on specific hardware support, may be adapted to various imaging sensors from different manufacturers, and has strong versatility.

The technical scheme of the present disclosure may be described below in combination with specific implementation scenarios.

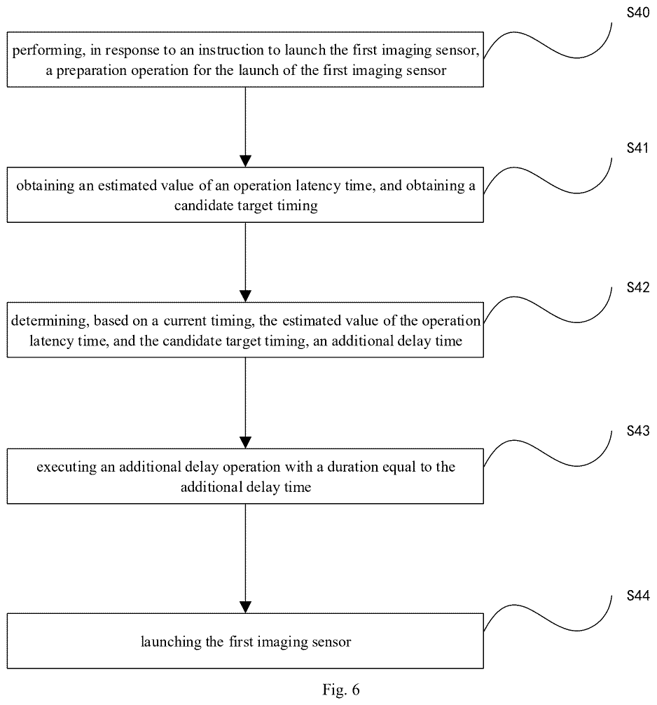

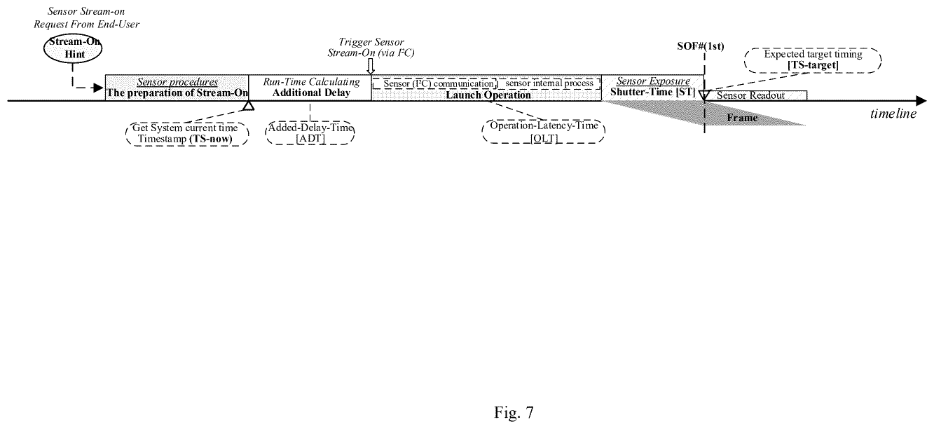

As illustrated in FIG. 1, FIG. 6, and FIG. 7, FIG. 6 is a schematic flowchart of a first-frame timing control method for the first imaging sensor of the imaging device according to some other embodiments of the present disclosure, and FIG. 7 is a timing diagram of streaming on the first imaging sensor and achieving timing synchronization in the first frame according to some embodiments of the present disclosure. As illustrated in FIG. 1, the imaging device may include the processor, the first imaging sensor, and the second imaging sensor. The first imaging sensor and the second imaging sensor are respectively electrically connected to the processor. In the present disclosure, there may be no direct information communication or signal transmission between different imaging sensors. The processor may serve as a host to observe the signals and timings of each imaging sensor, and handle timing cases, thereby tracing the status of the imaging sensors and realizing the control and operation of the imaging sensors. The method may include the following operations as illustrated at the blocks of FIG. 5.

The operation at block S40: In response to an instruction to launch the first imaging sensor, performing the preparation operation for launching the first imaging sensor.

In some embodiments, as described above, performing the preparation operation for launching the first imaging sensor may include at least one selected from the group consisting of: determining configuration parameters of the first imaging sensor by the processor; performing a power-on procedure for the first imaging sensor; and/or switching the first imaging sensor from the standby mode to an active mode.

In some embodiments, as illustrated in FIG. 6, when the preparation operation is completed, the processor may obtain the current system time, i.e., the current timing or current timestamp TS_{now}. The current timestamp may be used for subsequent calculation of the actual launch latency time.

The operation at block S41: Obtaining an estimated value of the operation latency time, and obtaining a candidate target timing.

As described above, the operation latency time may refer to the total duration from triggering the first-frame acquisition operation of the first imaging sensor to the first imaging sensor starting the exposure phase of the first-frame acquisition operation.

In some embodiments, the operation of obtaining the candidate target timing may include: obtaining an estimated value of the timing of the preset synchronization event of a future frame of the second imaging sensor. In a case where both the future frame of the second imaging sensor and the first frame of the first imaging sensor are in the single-exposure operation mode, the preset synchronization event of a frame is the start of exposure data readout of the frame. While in a case where both the future frame of the second imaging sensor and the first frame of the first imaging sensor are in the multiple-exposure operation mode, the preset synchronization event of a frame is the start of exposure data readout of the last exposure of the frame.

In some embodiments, the operation of obtaining a plurality of estimated timings corresponding to the preset synchronization events of a plurality of consecutive future frames of the second imaging sensor may include: obtaining a plurality of estimated timings corresponding to the preset synchronization events of the plurality of consecutive future frames of the second imaging sensor. For example, the processor may estimate the SOF (Start-Of-Frame) of the future frames based on the current exposure data and the predicted exposure duration.

The operation at block S42: Determining the additional delay time based on the current timing, the estimated value of the operation latency time, and the candidate target timing.

Specifically, the additional delay time may be configured to enable the timing of the preset synchronization event of the first frame of the first imaging sensor to be synchronized with the candidate target timing.

In some embodiments, the additional delay time may be calculated by subtracting the sum of the current timing, the estimated value of the operation latency time, and the first time interval of the first imaging sensor from the candidate target timing. The first time interval may be the duration from the start of the exposure phase to the preset synchronization event in the first frame of the first imaging sensor.

Specifically, one estimated timing may be selected from the plurality of estimated timings in ascending order, and subtract, from the selected one, the sum of the current timing, the estimated value of the operation latency time, and the first time interval of the first imaging sensor. The first positive result obtained may be the additional delay time. For details, reference may be made to the description of the operation at block S32 above.

The operation at block S43: Executing the additional delay operation with the duration equal to the additional delay time.

For details, reference may be made to the description of The operation at block S33 above.

Compared with the related art, the present disclosure may add the additional delay operation with the duration equal to the additional delay time before triggering the imaging sensor to stream on. This additional delay operation may ensure that, the first imaging sensor achieves the expected alignment effect in the first frame.

The operation at block S44: Launching the first imaging sensor.

In some embodiments, the processor may write the stream-on instruction to the first imaging sensor, and the first imaging sensor may then perform the internal processing before the exposure phase.

In some embodiments, in a case where the preparation operations for launching the second imaging sensor are performed during the process of performing the preparation operations for launching the first imaging sensor, after executing the preparation operations for launching the first imaging sensor in response to the instruction to launch the first imaging sensor, the method may further include: waiting for the completion of the preparation operations for launching the second imaging sensor.

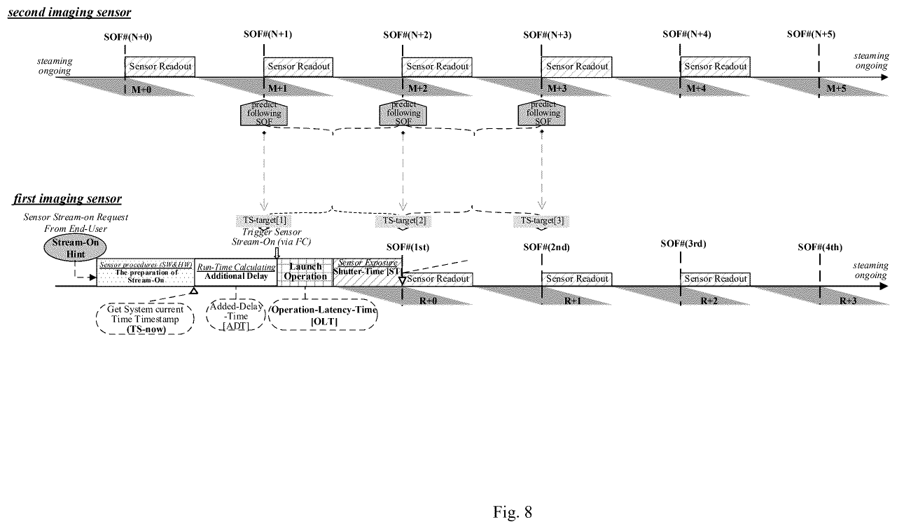

As illustrated in FIG. 8, FIG. 8 is a timing diagram of streaming on the first imaging sensor and achieving frame synchronization with the second imaging sensor in the first frame according to some embodiments of the present disclosure.

As illustrated in FIG. 8, when an end user requests to stream on the first imaging sensor, the second imaging sensor is in a streaming ongoing state. The second imaging sensor is in the single-exposure mode. The first imaging sensor will also adopt the single-exposure mode for image acquisition. The goal of the present disclosure is to achieve frame sync between the first imaging sensor and the second imaging sensor as much as possible in the first frame of the first imaging sensor.

After the operation at block S40 of FIG. 5, the processor may predict the SOF (Start-Of-Frame) of a future frame of the second imaging sensor as the candidate target timing. The processor may predict the SOF of the future frame based on the auto-exposure result of the second imaging sensor or the trend of previous frame length adjustment. Specifically, TS_{target}[1] is the timestamp of the next SOF of the second imaging sensor. TS_{target}[2]=TS_{target}[1]+the next frame length, . . . TS_{target}[i+1]=TS_{target}[i]+the next frame length, and so on.

The processor may then calculate the Additional Delay Time (ADT) according to Formula (1) described above, and execute the additional delay operation with the duration equal to the ADT. As illustrated in FIG. 7, by adding the additional delay operation, in the present embodiment, the first imaging sensor may achieve synchronization (Frame Sync) with the N+2 frame of the second imaging sensor in its first frame.

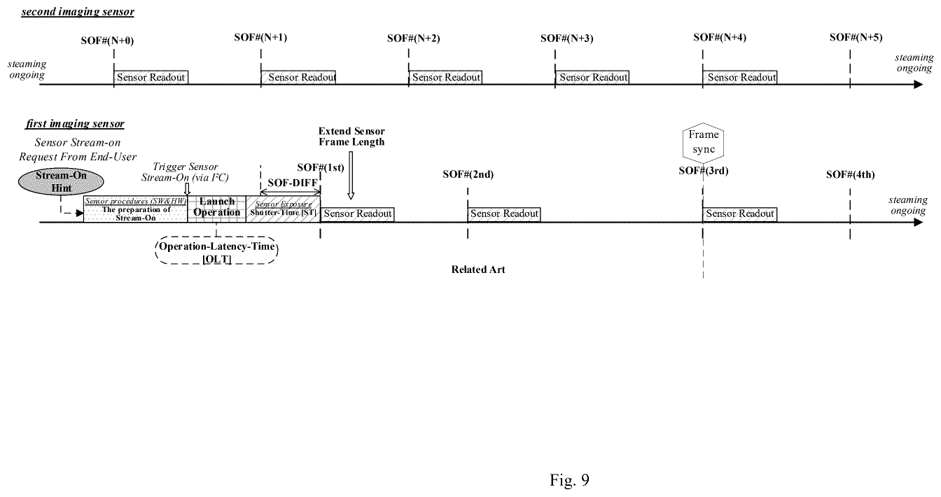

As illustrated in FIG. 9, FIG. 9 is a timing diagram of achieving frame synchronization between the first imaging sensor and the second imaging sensor after streaming on the first imaging sensor in the related art. As illustrated in FIG. 9, in the related art, after completing the preparation for launching the first imaging sensor, the processor may directly launch the first imaging sensor. After the operation latency time, the first imaging sensor may then perform exposure and exposure data readout for the first frame. Generally, in this case, the first frame of the first imaging sensor cannot achieve frame synchronization with the second imaging sensor. The processor may compare the difference between the SOF of the first frame of the first imaging sensor and the SOF of a certain frame of the second imaging sensor, and may extend the exposure duration of subsequent frames (e.g., the second frame) of the first imaging sensor, so as to achieve frame synchronization between the first imaging sensor and the second imaging sensor. In the example of FIG. 9, the first imaging sensor and the second imaging sensor may achieve frame synchronization only at the third frame of the first imaging sensor. It could be seen that, compared with the technical scheme in the related art illustrated in FIG. 9, the technical scheme of the present disclosure may achieve frame synchronization two frames earlier.

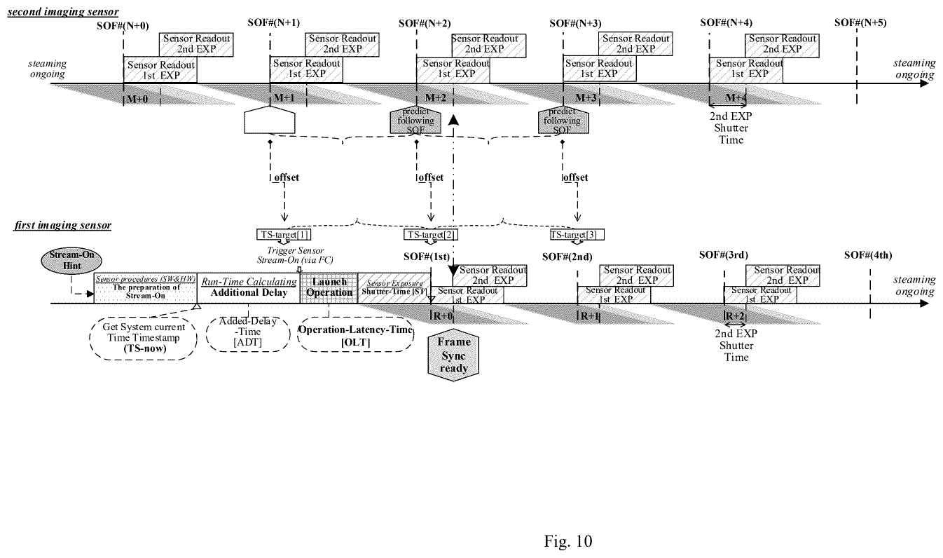

As illustrated in FIG. 10, FIG. 10 is a timing diagram of streaming on the first imaging sensor and achieving frame synchronization with the second imaging sensor in the first frame according to some embodiments of the present disclosure.

As illustrated in FIG. 10, when an end user requests to stream on the first imaging sensor, the second imaging sensor is in a streaming ongoing state. The second imaging sensor is in the double-exposure mode. The first imaging sensor will also adopt the double-exposure mode for image acquisition. The goal of the present disclosure is to achieve frame synchronization between the first imaging sensor and the second imaging sensor as much as possible in the first frame of the first imaging sensor.

As illustrated in FIG. 10, after the operation at block S40 in FIG. 5, due to an offset between the exposure data readout events of the first type of exposure process and the second type of exposure process, the processor may predict the start time of the exposure data readout of the last exposure process of a future frame of the second imaging sensor as the candidate target timing. The processor may predict the candidate target timing based on the auto-exposure result of the second imaging sensor or on the trend of previous frame length adjustment. Specifically, TS_{target}[1] is the timestamp of the start of the exposure data readout of the next last exposure process of the second imaging sensor. TS_{target}[2]=TS_{target}[1]+the next frame length, and so on.

The processor may then calculate the ADT according to Formula (1) described above, and execute the additional delay operation with the duration equal to the ADT. As illustrated in FIG. 10, by adding the additional delay operation, in the present embodiment, the first imaging sensor may achieve frame synchronization (Frame Sync) with the second imaging sensor in its first frame. Compared with the case in FIG. 8, in FIG. 10, the frame synchronization between the first imaging sensor and the second imaging sensor may be featured by: the synchronization between the start time of the exposure data readout of the last exposure process of the first frame of the first imaging sensor and the start time of the exposure data readout of the last exposure process of a certain frame of the second imaging sensor.

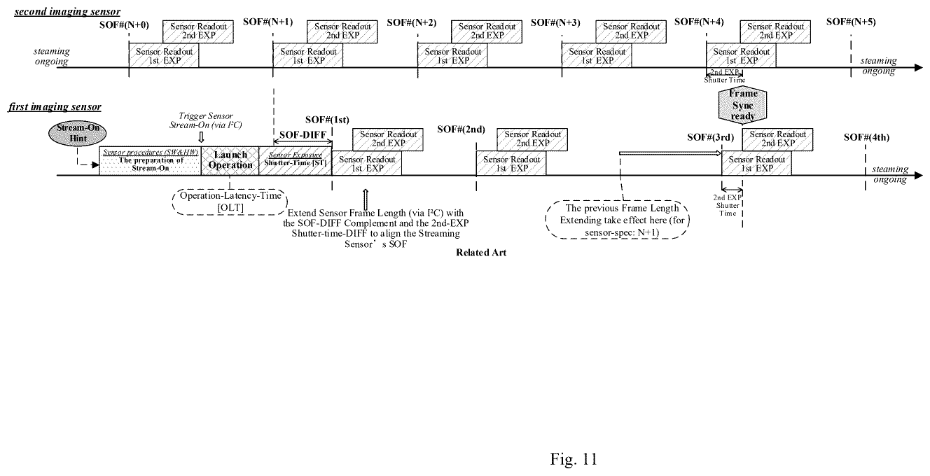

As illustrated in FIG. 11, FIG. 11 is a timing diagram of achieving frame synchronization between the first imaging sensor and the second imaging sensor after streaming on the first imaging sensor in the related art. Both the first imaging sensor and the second imaging sensor are in the double-exposure mode. Similar to the case in FIG. 9, in the case of FIG. 11, after the first frame of the first imaging sensor, the exposure duration of the second frame of the first imaging sensor may be extended, so as to achieve the frame synchronization between the first imaging sensor and the second imaging sensor. In the example of FIG. 11, the first imaging sensor and the second imaging sensor may achieve frame synchronization only at the third frame of the first imaging sensor. It could be seen that, compared with the technical scheme in the related art shown in FIG. 11, the technical scheme of the present disclosure in FIG. 10 may achieve frame synchronization between the two imaging sensors two frames earlier.

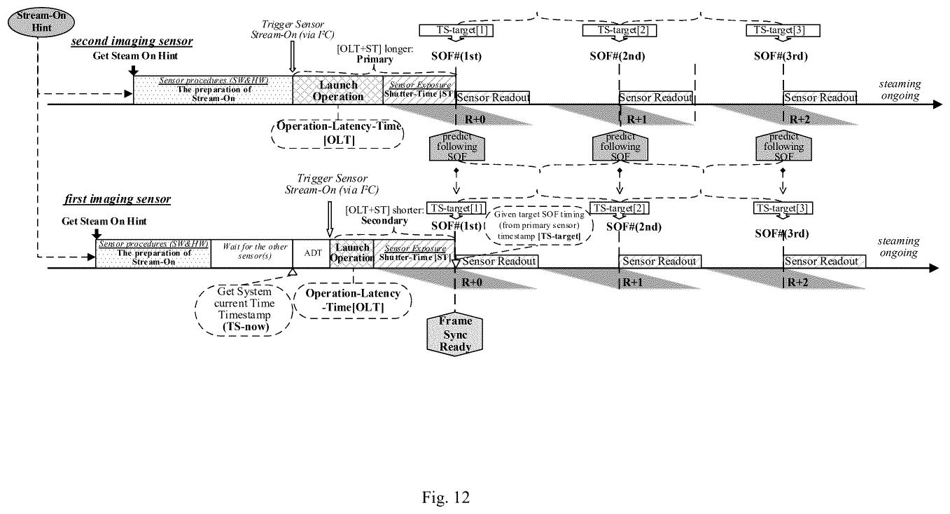

As illustrated in FIG. 12, FIG. 12 is a timing diagram of streaming on the first imaging sensor and the second imaging sensor and allowing the first imaging sensor to achieve, in its first frame, frame synchronization with the second imaging sensor according to some embodiments of the present disclosure.

In some embodiments, in the embodiment of FIG. 12, the launch preparation operations of the first imaging sensor and the second imaging sensor may be completed simultaneously. If the launch preparation operations of the first imaging sensor and the second imaging sensor are not completed simultaneously, the imaging sensor that completes the preparation first may wait for another imaging sensor to complete the launch preparation operations, so as to facilitate subsequent frame synchronization.

Subsequently, after the launch preparation operations of both the first imaging sensor and the second imaging sensor are completed, the total duration of the OLT (Operation-Latency-Time) and the first-frame exposure time of each sensor may be determined. The imaging sensor with the maximum total duration may be selected as a master sensor, and another imaging sensor may be determined as a slave sensor. The processor may then directly trigger the launch operation of the master sensor.

In the embodiment of FIG. 12, the second imaging sensor at the top of the drawing may serve as the master sensor, and the first imaging sensor at the bottom of the drawing may serve as the slave sensor.

Subsequently, the SOF of a future frame of the second imaging sensor may be used as the candidate target timing. Before the processor instructs to launch the first imaging sensor, the first imaging sensor may execute the additional delay operation, so as to allow the first imaging sensor to achieve, in its first frame, frame synchronization with the second imaging sensor. Details are not repeated herein.

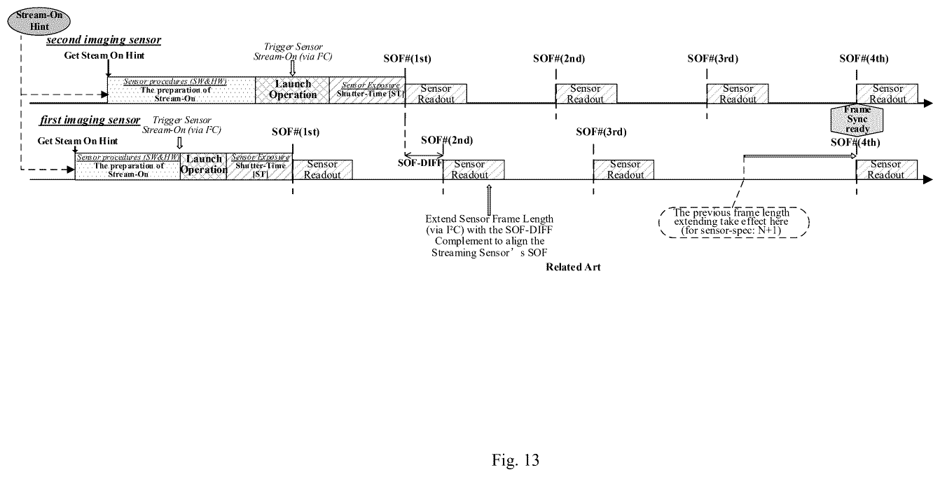

As illustrated in FIG. 13, FIG. 13 is a timing diagram of streaming on the first imaging sensor and the second imaging sensor and achieving frame synchronization between the first imaging sensor and the second imaging sensor in the related art.

As illustrated in FIG. 13, in the related art, the first imaging sensor and the second imaging sensor may respectively start the first-frame operation, and then the offset between the frames of the first imaging sensor and the second imaging sensor may be determined. The embodiment of FIG. 13 may achieve the frame synchronization between the first imaging sensor and the second imaging sensor by extending the exposure duration of subsequent frames of the first imaging sensor. In the embodiment of FIG. 13, the first imaging sensor may achieve the frame synchronization with the second imaging sensor only at a fourth frame after the first imaging sensor is launched. In other words, compared with the embodiment of FIG. 12, the technical scheme of the present disclosure may achieve the frame synchronization between the first imaging sensor and the second imaging sensor approximately three frames earlier.

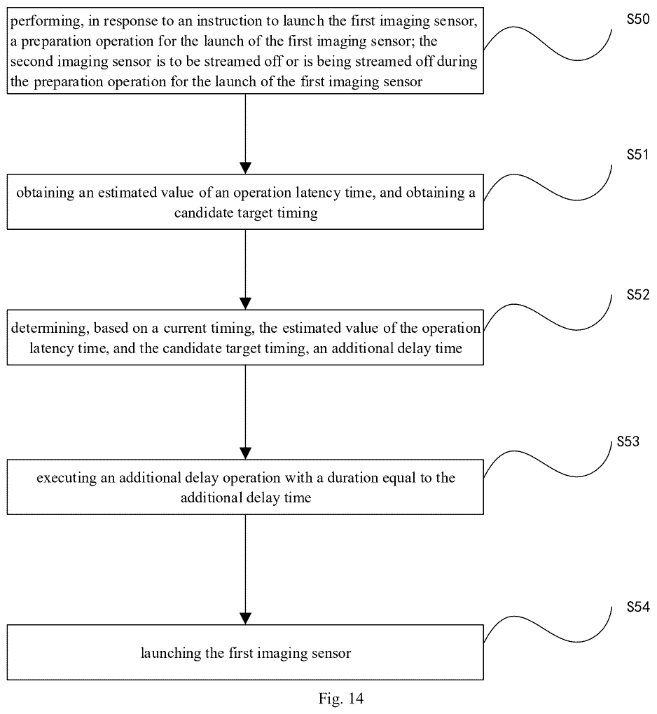

As illustrated in FIG. 1 and FIG. 14, FIG. 14 is a schematic flowchart of the first-frame timing control method for the first imaging sensor of the imaging device according to yet another embodiments of the present disclosure. As illustrated in FIG. 1, the imaging device may include the processor, the first imaging sensor, and the second imaging sensor. The first imaging sensor and the second imaging sensor are respectively electrically connected to the processor. The method may include the following operations as illustrated at blocks of FIG. 14.

The operation at block S50: In response to the instruction to launch the first imaging sensor, performing the preparation operation for launching the first imaging sensor. During the preparation operation for launching the first imaging sensor, the data stream of the second imaging sensor is to be streamed off or is being streamed off.

The preparation operations for launching the first imaging sensor are as described above, and would not be repeated herein.

The operation at block S51: Obtaining the estimated value of the operation latency time, and obtain the candidate target timing.

For the process of obtaining the estimated value of the operation latency time, reference may be made to other embodiments above, which would not be elaborated here.

Specifically, the candidate target timing may be the timing when the processor successfully releases the associated resources allocated for the second imaging sensor after the second imaging sensor is streamed off. For the definition associated resources, specific reference may be made to the description above.

The operation at block S52: Determining the additional delay time (ADT) based on the current timing, the estimated value of the operation latency time, and the candidate target timing.

Specifically, the additional delay time may be configured to enable the timing of the preset synchronization event of the first frame of the first imaging sensor to be synchronized with the candidate target timing.

In some embodiments, the additional delay time may be calculated by subtracting the sum of the current timing, the estimated value of the operation latency time, and the first time interval of the first imaging sensor from the candidate target timing. The first time interval is the duration from the start of the exposure phase to the preset synchronization event in the first frame of the first imaging sensor.

The operation at block S53: Execute the additional delay operation with the duration equal to the additional delay time.

For details of the present operation, reference may be made to the operation at block S33 in FIG. 5, which would not be repeated here.

The operation at block S54: Launching the first imaging sensor.

In some embodiments, the processor may write the stream-on instruction to the first imaging sensor, and the first imaging sensor may perform the internal processing before the exposure phase.

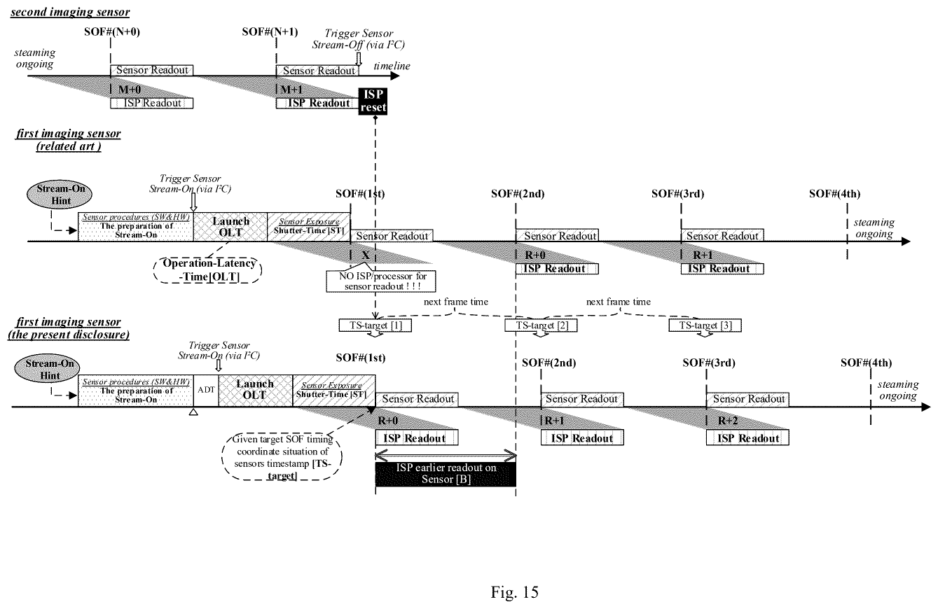

As illustrated in FIG. 15, FIG. 15 is, when the second imaging sensor is streaming off, a timing diagram of streaming on the first imaging sensor according to the related art and some embodiments of the present disclosure respectively.

As illustrated in FIG. 15, in the technical scheme of the present disclosure, the candidate target timing may be determined as the timing when the processor, after the second imaging sensor has been streamed off, successfully releases the associated resources allocated for the second imaging sensor. In this way, it can be ensured that, the SOF (Start-Of-Frame) of the first frame of the first imaging sensor may arrive after the processor releases the associated resources for the second imaging sensor, thereby ensuring that there is sufficient bandwidth for the transmission of the first-frame data of the first imaging sensor. On the contrary, in the related art, due to a lack of control over the first-frame timing, the data transmission of the first frame of the first imaging sensor may conflict with the data transmission of the second imaging sensor, resulting in loss of the first-frame data of the first imaging sensor.

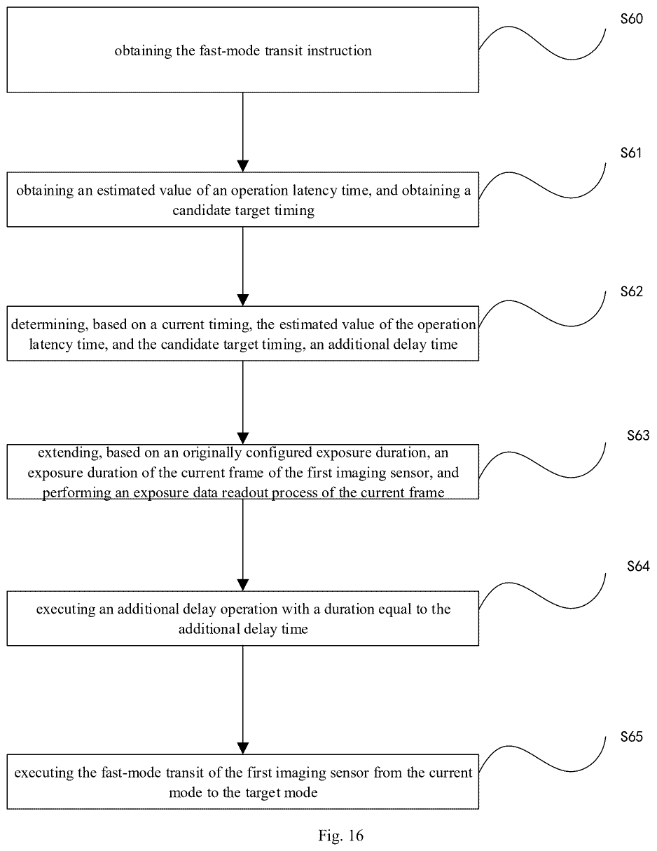

As illustrated in FIG. 1 and FIG. 16, FIG. 16 is a schematic flowchart of the first-frame timing control method for the first imaging sensor of the imaging device according to yet another embodiments of the present disclosure. As illustrated in FIG. 1, the imaging device may include the processor, the first imaging sensor, and the second imaging sensor. The first imaging sensor and the second imaging sensor are electrically connected to the processor respectively. The method may include the following operations at blocks of FIG. 15.

The operation at block S60: Obtaining a fast mode transit instruction.

For details, reference may be made to stage P21 described above in conjunction with FIG. 4, which would not be repeated here.

The operation at block S61: Obtaining an estimated value of the operation latency time, and obtaining the candidate target timing.

In some embodiments, obtaining the candidate target timing may means an operation of obtaining the estimated value of the timing of a preset synchronization event of a future frame of the second imaging sensor. In a case where both the future frame of the second imaging sensor and the first frame of the first imaging sensor in the target mode are in the single-exposure operation mode, the preset synchronization event of a frame is the start of exposure data readout of the frame. In a case where both the future frame of the second imaging sensor and the first frame of the first imaging sensor in the target mode are in the multiple-exposure operation mode, the preset synchronization event of a frame is the start of exposure data readout of the last exposure of the frame.

In some embodiments, the estimated value of the operation latency time may be obtained through the integrator. The integrator may specifically be the second type of integrator described above with reference to Table 2, i.e., the transit-OLT integrator, which would not be repeated here.

The operation at block S62: Determining the additional delay time based on the current timing, the estimated value of the operation latency time, and the candidate target timing.

The additional delay time may be configured to enable the timing of the preset synchronization event of the first frame of the first imaging sensor to be synchronized with the candidate target timing.

In some embodiments, the additional delay time may be calculated by subtracting, from the candidate target timing, the sum of the current timing, the estimated value of the operation latency time, and the first time interval of the first imaging sensor. The first time interval may be the duration from the start of the exposure phase to the preset synchronization event in the first frame of the first imaging sensor.

The operation at block S63: Extending, based on the originally configured exposure duration, the exposure duration of the current frame of the first imaging sensor; and, performing the exposure data readout process of the current frame.

In some embodiments, this operation may be used to reserve sufficient time for the processor to prepare for the fast mode transit of the first imaging sensor.

The operation at block S64: Executing the additional delay operation with the duration equal to the additional delay time.

The operation at block S65: Executing the fast mode transit operation of the first imaging sensor from the current mode to the target mode.

Specifically, as described above, in the case of fast mode transit, executing the fast mode transit operation of the first imaging sensor from the current mode to the target mode may include: the processor writing the fast mode transit instruction for switching to the target mode to the first imaging sensor, and the first imaging sensor performing internal processing before the exposure phase of the first frame in the target mode state.

In some embodiments, the processor may write the fast mode transit instruction of switching to the target mode to the first imaging sensor via the I2C protocol.

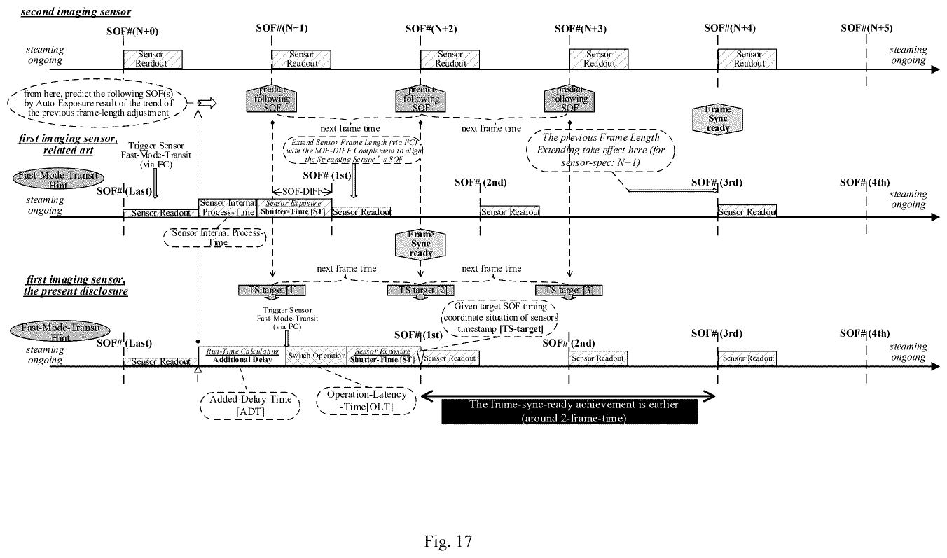

As illustrated in FIG. 17, FIG. 17 is, when the second imaging sensor is in a streaming-on state, the timing of fast mode transit of the first imaging sensor according to the related art and some embodiments of the present disclosure.

As illustrated in FIG. 17, in the technical scheme of the present disclosure, the candidate target timing is determined as the SOF of a future frame of the second imaging sensor. In this way, by adding the ADT, it can be ensured that, the SOF of the first frame of the first imaging sensor may be synchronized with the SOF of the second imaging sensor, thereby realizing that the first frame of the first imaging sensor is synchronized, after fast mode transit, with the frame of the second imaging sensor. On the contrary, in the related art, due to the lack of control over the first-frame timing, the first frame of the first imaging sensor usually cannot be synchronized with the frame of the second imaging sensor. The related art usually realizes frame synchronization between the first imaging sensor and the second imaging sensor by extending the exposure duration of subsequent frames of the first imaging sensor, and finally achieves frame synchronization with the second imaging sensor at the third frame of the first imaging sensor after switching to the target mode. It could be seen from FIG. 14 that, in the present embodiment, the technical scheme of the present disclosure may achieve frame synchronization approximately two frames earlier.

### Features of the Technical Scheme of the Present Disclosure in Industrial Applications

The first-frame signal output by the first imaging sensor through the Mobile Industry Processor Interface (MIPI) is aligned with the candidate target timing. Specifically, by observing a specific pin (e.g., MIPI pin) of the first imaging sensor using equipment such as an oscilloscope, a logic analyzer, or similar devices, it could be observed that, after applying the technical scheme of the present disclosure, the timing of the first signal (usually the Start-Of-Frame, SOF) in the first frame of the imaging sensor is often aligned with one of the SOF timings of another imaging sensor that is streaming on.

In addition, a time length distribution of the ADT for plurality of first frames of the first imaging sensor is non-uniform. Specifically, before the imaging sensor performs the stream-on operation, by monitoring a specific pin (e.g., I2C pin), an operation gap between the stream-on operation and the previous control operation could be detected. This operation gap may correspond to the ADT in the technical scheme of the present disclosure. The ADT is usually significant, and in a plurality of observations, the distribution of the ADT is often non-uniform or dynamically unstable.

Continuing to refer to FIG. 1, the imaging device 100 in FIG. 1 may include a processor 110. The processor 110 may be configured to execute each embodiment of the first-frame timing control method for the first imaging sensor described above.

If the integrated units in the above-mentioned other embodiments are implemented in the form of software functional units and sold or used as independent product, then they could be stored in a computer-readable storage medium. Based on such kind of understanding, the technical solution of the present disclosure essentially or a part contributing to the prior art or part or all of the technical solution may be embodied in the form of software products. The computer software products may be stored in one storage medium. The computer software products may include some instructions for causing a computer device (which may be a personal computer, a server or a network device, etc.) or a processor to implement all or part of the operations of the methods described in various embodiments of the present disclosure. The afore-mentioned storage medium may include: U disk, mobile hard disk drive, read-only memory (ROM), random access memory (RAM), magnetic disk or CD-ROM and other media that can store program codes.

The above are only implementations of the present disclosure, and do not limit the patent scope of the present disclosure. Any equivalent changes to the structure or processes made by the description and drawings of this application or directly or indirectly used in other related technical field are included in the protection scope of this application.

What is claimed is:

1. A method for controlling a first-frame timing of a first imaging sensor in an imaging device, comprising:
obtaining an estimated value of an operation latency time, and obtaining a candidate target timing;
determining, based on a current timing, the estimated value of the operation latency time, and the candidate target timing, an additional delay time;
executing an additional delay operation with a duration equal to the additional delay time; and
triggering a first-frame acquisition operation of the first imaging sensor;
wherein the operation latency time is a total duration from triggering the first-frame acquisition operation of the first imaging sensor to the first imaging sensor starting an exposure phase of the first-frame acquisition operation;
the additional delay time is configured to enable a timing of a preset synchronization event of a first frame of the first imaging sensor to synchronize with the candidate target timing.

2. The method as claimed in claim 1, wherein
the determining, based on the current timing, the estimated value of the operation latency time, and the candidate target timing, the additional delay time comprises:
calculating the additional delay time as a result obtained by subtracting a sum of the current timing, the estimated value of the operation latency time, and a first time interval of the first imaging sensor from the candidate target timing;
wherein the first time interval is a duration from when the first imaging sensor starts the exposure phase to the preset synchronization event in the first frame.

3. The method as claimed in claim 2, wherein
before obtaining the estimated value of the operation latency time, and obtaining the candidate target timing, the method further comprises:
performing, in response to an instruction to launch the first imaging sensor, a preparation operation for the launch of the first imaging sensor;
the triggering the first-frame acquisition operation of the first imaging sensor comprises:
launching the first imaging sensor.

4. The method as claimed in claim 3, wherein
the imaging device further comprises a processor electrically connected to the first imaging sensor;
the performing the preparation operation for the launch of the first imaging sensor comprises at least one selected from the group consisting of:
determining, by the processor, configuration parameters for the first imaging sensor;
performing a power-on procedure for the first imaging sensor; and/or
transiting the first imaging sensor from a standby mode to an active mode; and/or
the launch the first imaging sensor comprises:
writing, by the processor, a stream-on instruction to the first imaging sensor; and
the first imaging sensor performing an internal processing before the exposure phase;
wherein the operation latency time is an operation time for launching the first imaging sensor.

5. The method as claimed in claim 3, wherein
the processor is an image signal processor or an application processor; and/or
the writing, by the processor, the stream-on instruction to the first imaging sensor comprises:
the processor writing, based on an I2C protocol, the stream-on instruction to the first imaging sensor.

6. The method as claimed in claim 3, wherein
the obtaining the estimated value of the operation latency time comprises:
obtaining, through an integrator, the estimated value of the operation latency time;
wherein the integrator is configured to collect actual values of the operation latency time of a plurality of first frames of the first imaging sensor, and to perform statistical processing on the actual values to generate the estimated value; each integrator corresponds to only one operation mode of one first imaging sensor.

7. The method as claimed in claim 3, wherein
the imaging device further comprises a second imaging sensor;
the obtaining the candidate target timing comprises:
obtaining an estimated value of a timing of a preset synchronization event of a future frame of the second imaging sensor;
wherein, in a case where both the future frame of the second imaging sensor and the first frame of the first imaging sensor are in a single-exposure operation mode, the preset synchronization event of a frame is start of exposure data readout of the frame; and/or, in a case where both the future frame of the second imaging sensor and the first frame of the first imaging sensor are in a multiple-exposure operation mode, the preset synchronization event of a frame is start of exposure data readout of the last exposure of the frame.

8. The method as claimed in claim 7, wherein
the obtaining the estimated value of the timing of the preset synchronization event of the future frame of the second imaging sensor comprises:
obtaining a plurality of estimated timings corresponding to the preset synchronization events of a plurality of consecutive future frames of the second imaging sensor;
the calculating the additional delay time as a result obtained by subtracting a sum of the current timing, the estimated value of the operation latency time, and the first time interval of the first imaging sensor from the candidate target timing comprises:
selecting one from the plurality of estimated timings in an ascending order, subtracting a sum of the current timing, the estimated value of the operation latency time, and the first time interval of the first imaging sensor, and taking a first positive result obtained as the additional delay time.

9. The method as claimed in claim 7, wherein
in a case where a preparation operation for launching the second imaging sensor is performed during performing the preparation operation for the launching of the first imaging sensor, after performing, in response to the instruction to launch the first imaging sensor, the preparation operation for the launch of the first imaging sensor, the method further comprises:
waiting for a completion of the preparation operation for launching the second imaging sensor.

10. The method as claimed in claim 3, wherein
the imaging device further comprises a second imaging sensor;
in a case where the second imaging sensor is to be streamed off or is being streamed off during the preparation operation for the launch of the first imaging sensor, the candidate target timing is: after the second imaging sensor has been streamed off, the processor successfully releases associated resources allocated for the second imaging sensor.

11. The method as claimed in claim 2, wherein
the triggering the first-frame acquisition operation of the first imaging sensor comprises:
performing a fast mode transit operation of the first imaging sensor from a current mode to a target mode.

12. The method as claimed in claim 11, wherein
before executing the additional delay operation with the duration equal to the additional delay time, the method further comprises:
in response to an instruction to perform the fast mode transit for the first imaging sensor, extending, based on an originally configured exposure duration, an exposure duration of the current frame of the first imaging sensor, and performing an exposure data readout process of the current frame.

13. The method as claimed in claim 11, wherein
the imaging device further comprises a processor electrically connected to the first imaging sensor;
the performing the fast mode transit operation of the first imaging sensor from the current mode to the target mode comprises:
writing, by the processor to the first imaging sensor, a fast mode transit instruction to transit to the target mode; and
performing, by the first imaging sensor, an internal processing before an exposure phase of the first frame in the target mode state.

14. The method as claimed in claim 13, wherein
the processor is an image signal processor or an application processor; and/or
the writing, by the processor to the first imaging sensor, the fast mode transit instruction to transit to the target mode comprises:
writing, by the processor to the first imaging sensor via an I2C protocol, the fast mode transit instruction to transit to the target mode.

15. The method as claimed in claim 11, wherein
the obtaining the estimated value of the operation latency time comprises:
obtaining the estimated value of the operation latency time through an integrator;
wherein the integrator is configured to collect an actual value of the operation latency time for transiting from the current mode to the target mode when the first imaging sensor performs the additional delay operation, and to perform statistical processing on the actual value to generate the estimated value; each integrator corresponds to only one operation mode transiting scenario of one first imaging sensor.

16. The method as claimed in claim 11, wherein
the imaging device further comprises a second imaging sensor;
the obtaining the candidate target timing comprises:
obtaining an estimated value of a timing of a preset synchronization event of a future frame of the second imaging sensor;
wherein, in a case where both the future frame of the second imaging sensor and the first frame of the first imaging sensor in the target mode are in a single-exposure operation mode, the preset synchronization event of a frame is a start of exposure data readout of the frame; and/or, in a case where both the future frame of the second imaging sensor and the first frame of the first imaging sensor in the target mode are in a multiple-exposure operation mode, the preset synchronization event of a frame is a start of exposure data readout of the last exposure of the frame.

17. The method as claimed in claim 1, wherein
a first frame signal output by the first imaging sensor through a Mobile Industry Processor Interface is aligned with the candidate target timing; and/or
a length distribution of the additional delay times for multiple first frames of the first imaging sensor is non-uniform.

18. An imaging device, comprising a first imaging sensor and a processor electrically connected to each other, wherein
the processor is configured to execute a first-frame timing control method for the first imaging sensor, the control method comprises:
obtaining an estimated value of an operation latency time, and obtaining a candidate target timing;
determining, based on a current timing, the estimated value of the operation latency time, and the candidate target timing, an additional delay time;
executing an additional delay operation with a duration equal to the additional delay time; and
triggering a first-frame acquisition operation of the first imaging sensor;
wherein the operation latency time is a total duration from triggering the first-frame acquisition operation of the first imaging sensor to the first imaging sensor starting an exposure phase of the first-frame acquisition operation;
the additional delay time is configured to enable a timing of a preset synchronization event of a first frame of the first imaging sensor to synchronize with the candidate target timing.

19. The imaging device as claimed in claim 18, wherein
the determining, based on the current timing, the estimated value of the operation latency time, and the candidate target timing, the additional delay time comprises:
calculating the additional delay time as a result obtained by subtracting a sum of the current timing, the estimated value of the operation latency time, and a first time interval of the first imaging sensor from the candidate target timing;
wherein the first time interval is a duration from when the first imaging sensor starts the exposure phase to the preset synchronization event in the first frame.

20. The imaging device as claimed in claim 19, wherein
the triggering the first-frame acquisition operation of the first imaging sensor comprises:
launching the first imaging sensor; or
performing a fast mode transit operation of the first imaging sensor from a current mode to a target mode.
